(19) United States
(12) Patent Application Publication
(10) Pub. No.: US 2007/0263317 A1
(43) Pub. Date: Nov. 15, 2007

(54) Method and apparatus for balanced dual stage actuators in a head stack assembly of a hard disk drive

(75) Inventors: Haesung Kwon, San Jose, CA (US); Jai Lee Hyung, Cupertino, CA (US); Young-Hoon Kim, Santa Clara, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 11/433,157

(22) Filed: May 12, 2006

(51) Int. Cl. G11B 5/596

(52) U.S. Cl. 360/78.12; 360/78.04

(57) ABSTRACT

Head stack assembly coupling at least two micro-actuators sharing lateral control signal. Any two adjacent micro-actuators respond to lateral control signal by opposite lateral directions. With pairs of micro-actuators, lateral motion of the micro-actuators will be cancelled, essentially leaving head stack assembly without induced torque. With odd numbers of micro-actuators, head stack assembly will effectively experience only lateral motion of one micro-actuator, minimizing induced torque. The micro-actuators may use electrostatic effect and/or piezoelectric effect to create lateral motion. The micro-actuators may further include a vertical actuation capability, which may preferably be independent of the lateral control signal. The servo controller operates based upon micro-actuator being used. Embedded circuit includes servo controller. The hard disk drive containing head stack assembly and further containing servo controller. Manufacturing hard disk drive and head stack assembly. The head stack assembly and hard disk drive, as products of these manufacturing processes.

### TECHNICAL FIELD

This invention relates to hard disk drives, in particular, to methods and apparatus minimizing the torque induced on a head stack assembly balancing the coupled micro-actuators in a lateral direction.

### BACKGROUND OF THE INVENTION

Contemporary hard disk drives include an head stack assembly pivoting through an actuator pivot to position one or more read-write heads, embedded in sliders, each over a rotating disk surface. The data stored on the rotating disk surface is typically arranged in concentric tracks. To access the data of a track, a servo controller first positions the read-write head by electrically stimulating the voice coil motor, which couples through the voice coil and an actuator arm to move a head gimbal assembly in positioning the slider close to the track. Once the read-write head is close to the track, the servo controller typically enters an operational mode known herein as track following. It is during track following mode that the read-write head is used to access data stored in the track.

Micro-actuators provide a second actuation stage for positioning the read-write head during track following mode. They often use an electrostatic effect and/or a piezoelectric effect to rapidly make fine position changes. They have doubled the bandwidth of servo controllers and are believed essential for high capacity hard disk drives from hereon.

There is a problem with micro-actuators as used in some head stack assemblies. The micro-actuators may share a common lateral micro-actuator control signal, which minimizes the signals coupling the micro-actuators with the servo controller. When the lateral micro-actuator control signal drives one micro-actuator in a direction, it drives all the micro-actuators in the head stack assembly in the same direction, which adds torque to the head stack assembly. What is needed is a way to minimize torque while minimizing the signals needed for lateral control.

### SUMMARY OF THE INVENTION

The invention includes a head stack assembly coupling to at least two micro-actuators sharing a lateral control signal. Any two adjacent micro-actuators respond to the lateral control signal by laterally moving in opposite directions. Consequently, when there is an even number of micro-actuators, lateral motion of the micro-actuators will be cancelled, essentially leaving the head stack assembly without an induced torque. When there is an odd number of micro-actuators, the head stack assembly will effectively experience only the lateral motion of one micro-actuator, because the pairs will have cancelled each other, minimizing the induced torque.

The invention includes the operation of the head stack assembly minimizing torque through the operation of the micro-actuators based upon the shared lateral control signal. The micro-actuators may use an electrostatic effect and/or a piezoelectric effect to create the lateral motion. The micro-actuators may further include a vertical actuation capability, which may preferably be independent of the lateral control signal.

The invention includes the servo controller operating the head stack assembly based upon which micro-actuator is being used. When the micro-actuator to be used has an even micro-actuator number, the servo controller provides the lateral control signal with a first polarity for clockwise lateral motion. When an odd-numbered micro-actuator is used, the servo controller provides the lateral control signal with a second polarity for clockwise lateral motion. The first and second polarities are opposite each other. The servo controller may include a servo computer accessibly coupled with a memory containing a program system to implement these operations.

Alternatively, the servo controller may be implemented to support the lateral control signal having the first polarity to cause counter-clockwise lateral motion when the micro-actuator number is even.

The invention includes the hard disk drive containing the head stack assembly and, preferably, further containing the servo controller for operating the head stack assembly. An embedded circuit may preferably include the servo controller.

The invention includes manufacturing the hard disk drive using the head stack assembly and further preferably using the servo controller to operate the head stack assembly. Manufacturing the head stack assembly includes assembling the head stack with the head gimbal assemblies and the lateral control signal so that the lateral control signal drives each two adjacent micro-actuators in opposite lateral directions, to create the head stack assembly. The invention includes the head stack assembly and the hard disk drive, as products of these manufacturing processes.

### BRIEF DESCRIPTION OF THE DRAWINGS

FIGS. 1 to 2B show various aspects of the invention in terms of the basic components of the hard disk drive, including the invention's head stack assembly;

FIG. 3 shows some details of the head gimbal assembly of FIGS. 1 to 2B;

FIG. 4A shows a top view of a partially assembled hard disk drive;

FIG. 4B shows a side view of the head gimbal assembly as used in the preceding Figures;

FIG. 5 shows an exploded view of the invention's hard disk drive; and

FIGS. 6A and 6B show an example of the micro-actuators used by adjacent head gimbal assemblies in the head stack assembly of FIG. 1.

### DETAILED DESCRIPTION

This invention relates to hard disk drives, in particular, to methods and apparatus minimizing the torque induced on a head stack assembly balancing the coupled micro-actuators in a lateral direction.

The invention includes a head stack assembly coupling to at least two micro-actuators sharing a lateral control signal. Any two adjacent micro-actuators respond to the lateral control signal by laterally moving in opposite directions. Consequently, when there is an even number of micro-actuators, lateral motion of the micro-actuators will be cancelled, essentially leaving the head stack assembly without an induced torque. When there is an odd number of micro-actuators, the head stack assembly will effectively experience only the lateral motion of one micro-actuator, because the pairs will have cancelled each other, minimizing the induced torque.

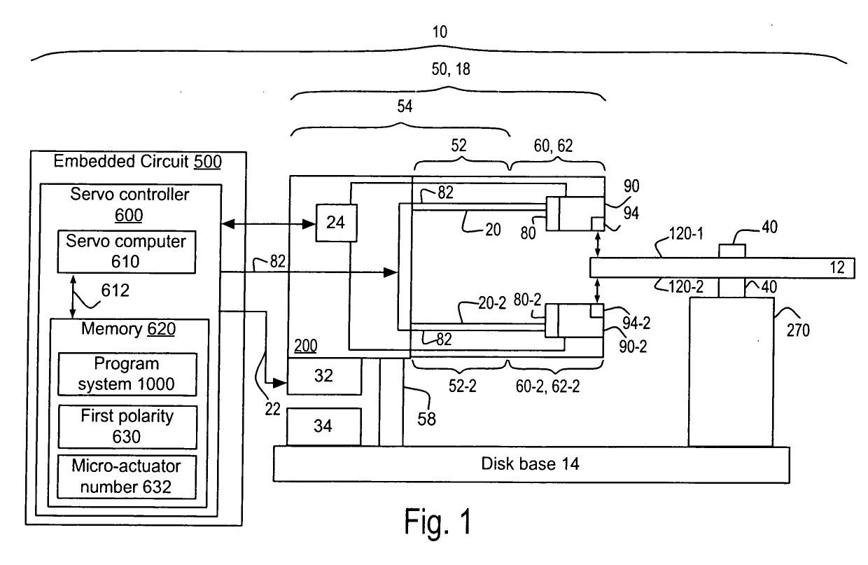

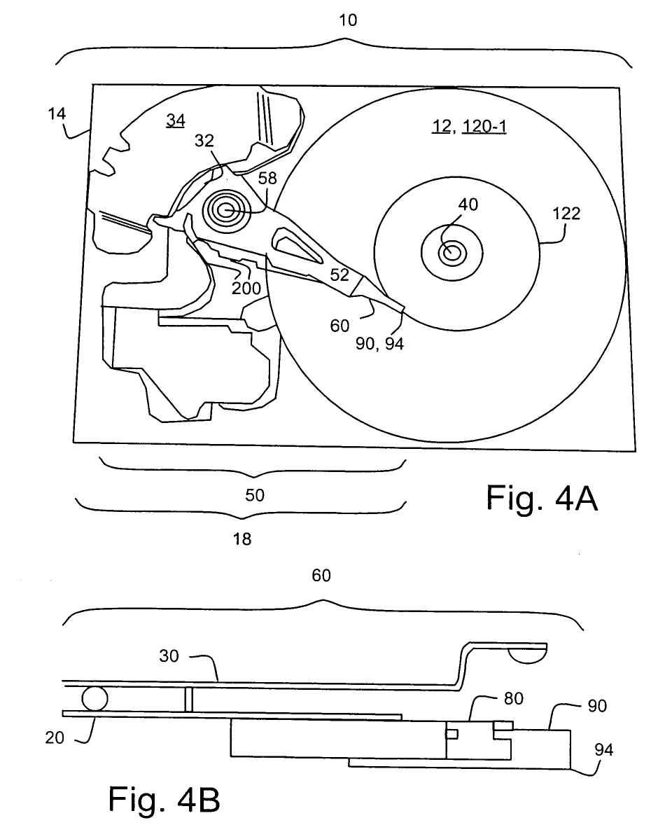

By way of example, FIG. 1 shows a head stack assembly 50 coupling to a micro-actuator 80 and a second micro-actuator 80-2 sharing a lateral control signal 82. The two micro-actuators are adjacent, and respond to the lateral control signal by laterally moving in opposite directions. As used herein, lateral motion of the micro-actuator refers to motion essentially in the plane of the rotating disk surface 120-1. Lateral motion of the second micro-actuator refers herein to the plane of the second rotating disk surface 120-2. Suppose that the micro-actuator 80 moves clockwise as shown in FIG. 4A. Then second micro-actuator 80-2 moves counter-clockwise. The lateral motion of these micro-actuators cancel each other, essentially leaving the head stack assembly without an induced torque from the lateral motion of these micro-actuators.

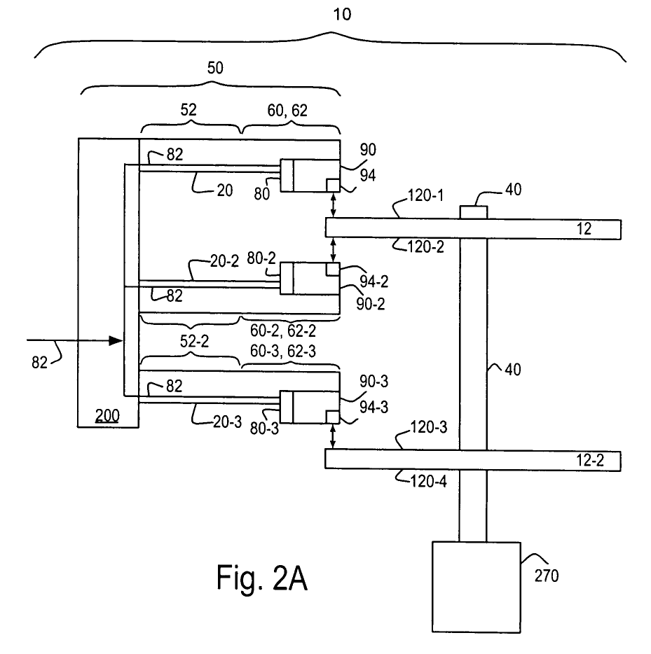

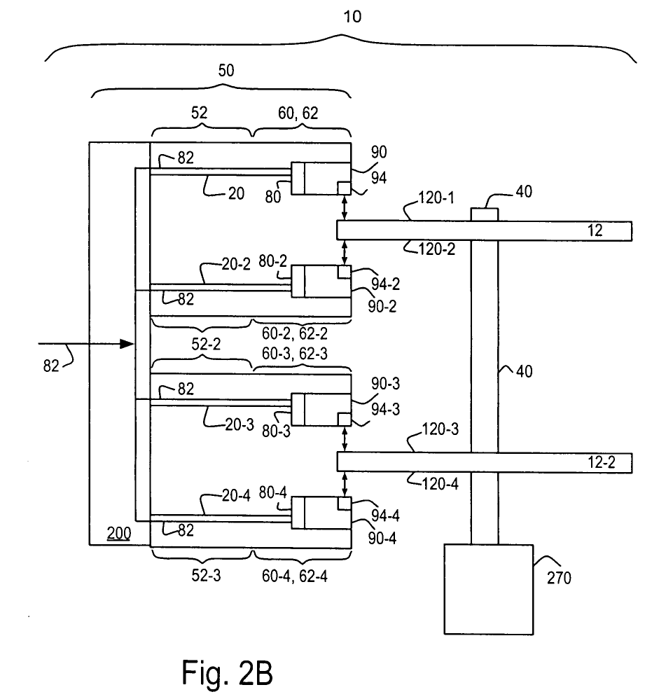

FIG. 2A shows the head stack assembly 50 of FIG. 1 further coupling to a third micro-actuator 80-3. As before, the micro-actuator is adjacent to the second micro-actuator. And now the second micro-actuator is adjacent to the third micro-actuator. The adjacent micro-actuators respond to the lateral control signal 82 by laterally moving in opposite directions. Suppose again that the micro-actuator 80 moves clockwise as shown in FIG. 4A. Then second micro-actuator 80-2 moves counter-clockwise, and the third micro-actuator 80-3 moves clockwise. The head stack assembly will effectively experience only the lateral motion of one micro-actuator, say the third micro-actuator, because the pair of adjacent micro-actuators 80-1 and 80-2 have cancelled each other as before, minimizing the induced torque.

FIG. 2B shows the head stack assembly 50 of FIG. 2A further coupling to a fourth micro-actuator 80-4. Now the third micro-actuator is adjacent to the fourth micro-actuator. The adjacent micro-actuators respond to the lateral control signal 82 by laterally moving in opposite directions. Suppose again that the micro-actuator 80 moves clockwise as shown in FIG. 4A. Then second micro-actuator 80-2 and the fourth micro-actuator 80-4 move counter-clockwise, the third micro-actuator 80-3 also moves clockwise. The lateral motion of the two pairs of adjacent micro-actuators cancel each other, essentially leaving the head stack assembly without an induced torque from the lateral motion of these micro-actuators.

To summarize, when there is an even number of micro-actuators, lateral motion of the micro-actuators will be cancelled, essentially leaving the head stack assembly without an induced torque. When there is an odd number of micro-actuators, the head stack assembly will effectively experience only the lateral motion of one micro-actuator, because the pairs will have cancelled each other, minimizing the induced torque.

The invention includes the operation of the head stack assembly 50 minimizing torque through the operation of the micro-actuators based upon a shared lateral control signal 82. The micro-actuators may use an electrostatic effect and/or a piezoelectric effect to create the lateral motion. By way of example, FIGS. 1 to 2B would operate identically in terms of the invention with micro-actuators using either an electrostatic effect and/or a piezoelectric effect to create the lateral motion. The micro-actuators may further include a vertical actuation capability, which may preferably be independent of the lateral control signal.

The invention further includes the hard disk drive 10 containing the head stack assembly 50, as shown in FIGS. 1 to 2B, 4A, and 5. The head stack assembly pivots through an actuator pivot 58 to position the read-write head 94, embedded in each slider 90, each over a rotating disk surface 120-1. To elaborate on the examples, the second read-write head 94-2 is embedded in the second slider 90-2 near the second rotating disk surface 120-2. The third read-write head 94-3 is embedded in the third slider 90-3 near the third rotating disk surface 120-3. The fourth read-write head 94-4 is embedded in the fourth slider 90-4 near the fourth rotating disk surface 120-4.

To further elaborate, the micro-actuator 80 is coupled with the slider 90 to laterally move the read-write head 94 over the rotating disk surface 120-1, as in FIGS. 1 to 4A. The second micro-actuator 80-2 is coupled with the second slider 90-2 to laterally move the second read-write head 94-2 over the second rotating disk surface 120-2. The third micro-actuator 80-3 is coupled with the third slider 90-3 to laterally move the third read-write head 94-3 over the third rotating disk surface 120-3. The fourth micro-actuator 80-4 is coupled with the fourth slider 90-4 to laterally move the fourth read-write head 94-4 over the fourth rotating disk surface 120-4.

The data stored on the rotating disk surface 120-1 is typically arranged in concentric tracks, as shown in FIG. 4A. To access the data of a track 122, the servo controller 600 first positions the read-write head 94 by electrically stimulating the voice coil motor 18 using the voice coil signal 22 as shown in FIG. 1. The voice coil motor operates by inducing the voice coil to move based upon the time varying electromagnetic field generated by the voice coil interacting with the fixed magnet 34. The voice coil 32 is coupled with an actuator arm 52 to move a head gimbal assembly 60 in positioning the slider close to the track.

Once the read-write head 94 is close to the track 122, the servo controller 600 typically enters an operational mode known herein as track following. It is during track following mode that the read-write head is used to access data stored in the track. The micro-actuator 80 provides a second actuation stage for positioning the read-write head during track following mode. It may use an electrostatic effect and/or a piezoelectric effect to rapidly make fine position changes.

The invention includes manufacturing the hard disk drive using the head stack assembly and further preferably using the servo controller to operate the head stack assembly. Manufacturing the head stack assembly includes assembling the head stack with the head gimbal assemblies and the lateral control signal so that the lateral control signal drives each two adjacent micro-actuators in opposite lateral directions, to create the head stack assembly. The invention includes the head stack assembly and the hard disk drive, as products of these manufacturing processes.

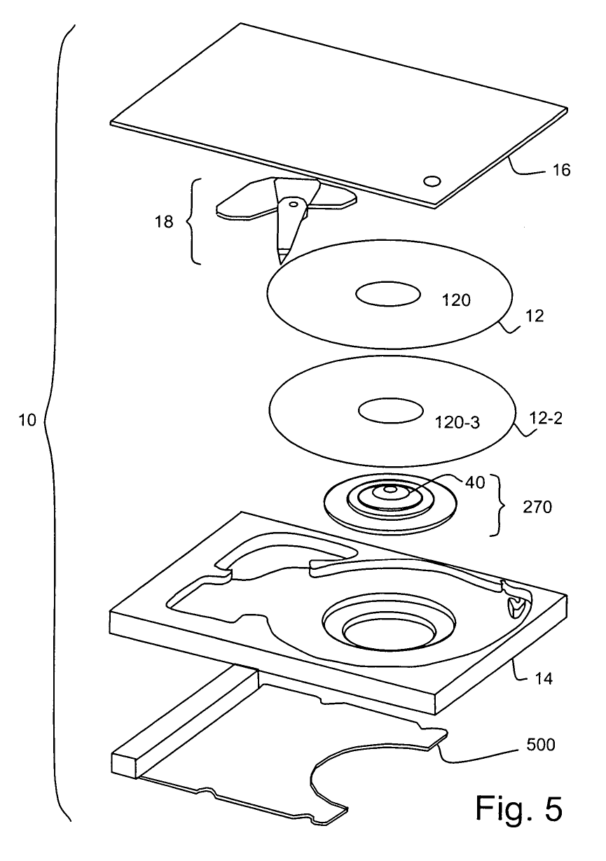

The invention includes the servo controller 600 operating the head stack assembly 50 based upon which micro-actuator is being used. When the micro-actuator to be used has an even micro-actuator number 632, the servo controller provides the lateral control signal 82 with a first polarity 630 for clockwise lateral motion, as shown in FIG. 1. When an odd-numbered micro-actuator is used, the servo controller provides the lateral control signal with a second polarity for clockwise lateral motion. The first and second polarities are opposite each other. The servo controller 600 may preferably be included in an embedded circuit 500, as in FIGS. 1 and 5.

The servo controller 600 may include a servo computer 610 accessibly coupled 612 with a memory 620 containing a program system 1000 to implement these operations. The servo computer may preferably include at least one instruction processor and at least one data processor, with each of the data processors directed by at least one of the instruction processors. The memory may include at least one instance of a non-volatile memory component and/or a volatile memory component. As used herein, a non-volatile memory component retains its memory contents without requiring a steady source of power, whereas a volatile memory loses its memory contents without a steady source of power. A steady source of power may be a constant amplitude either AC or DC power signal, or a succession of timed pulses, as is commonly used with Dynamic RAMs (DRAMs).

Alternatively, the servo controller 600 may be implemented to support the lateral control signal 82 having the first polarity 630 to cause counter-clockwise lateral motion when the micro-actuator number 632 is even.

The invention includes the hard disk drive 10 containing the head stack assembly 50 and, preferably, further containing the servo controller 600 for operating the head stack assembly.

The invention includes manufacturing the hard disk drive 10 using the head stack assembly 50 by mounting the head stack assembly through its actuator pivot 58 to the disk base 14, as shown in FIGS. 1 and 4A so that it pivots about the actuator pivot in the lateral plane. Manufacturing the hard disk drive may also preferably include electrically coupling the servo controller 600 to the head stack assembly 50, supporting the servo controller operating the head stack assembly in accord with the invention.

Manufacturing the head stack assembly includes assembling the head stack with the head gimbal assemblies and the lateral control signal so that the lateral control signal drives each two of the micro-actuators in adjacent head gimbal assemblies in opposite lateral directions, to create the head stack assembly.

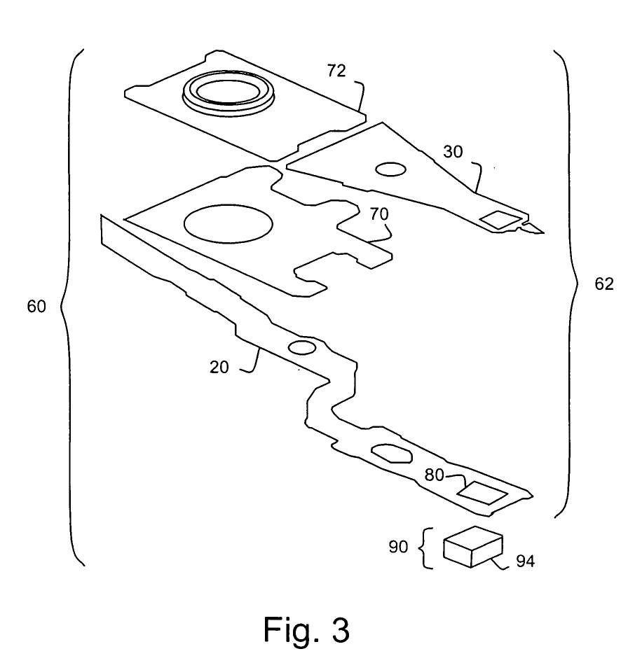

By way of example, manufacturing the head stack assembly 50 of FIG. 1 includes assembling the head stack 54 with the head gimbal assembly 60, the second head gimbal assembly 60-2, and the lateral control signal 82. To further develop this example, the head gimbal assembly 60 may use a micro-actuator as shown in FIGS. 3, 4B and 6A. FIG. 3 shows an exploded view of the head gimbal assembly and FIG. 4B shows a side view.

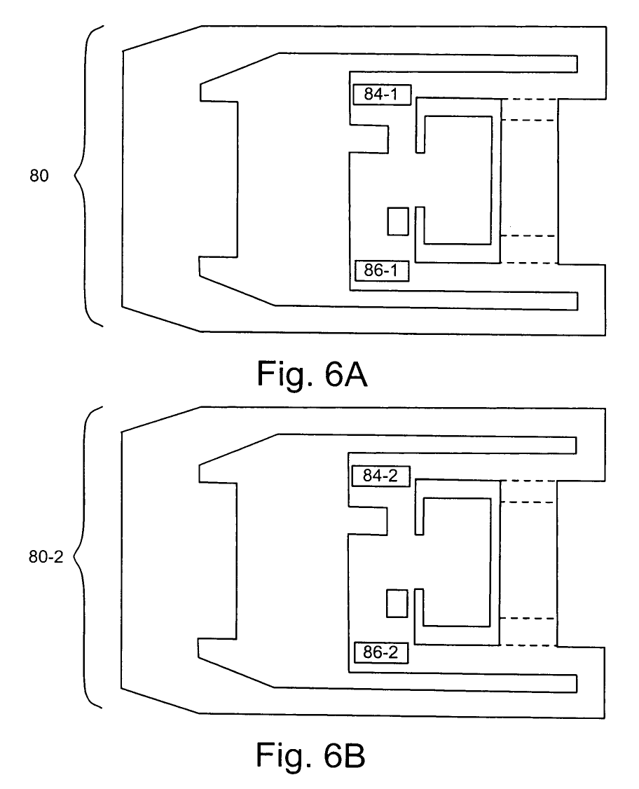

FIG. 6A shows the micro-actuator 80 as seen looking toward the rotating disk surface 120-1, with a first piezoelectric element 84-1 and a second piezoelectric element 86-1 causing lateral motion of the read-write head in response to the lateral control signal 82. The first piezoelectric element and the second piezoelectric element each typically have two electrical terminals, which are organized by the assembly process to form a first poling.

FIG. 6B shows the second micro-actuator 80-2 as seen in the same direction as FIG. 6A, with a first piezoelectric element with second poling 84-2 and a second piezoelectric element with second poling 86-2. This poling causes the second read-write head 94-2 to laterally move in the opposite direction to the micro-actuator 80 in FIG. 1. While this extended example has been developed for micro-actuators using a piezoelectric effect for lateral motion, the invention equally applies to micro-actuators using an electrostatic effect for lateral motion, by reversing the leads to the adjacent micro-actuators, their read-write heads laterally move in opposite directions.

The head gimbal assembly 60 of FIGS. 3 and 4B may be organized into a head suspension assembly 62 coupling the flexure finger 20 to the micro-actuator 80, which in turn is coupled with the slider 90, in which the read-write head 94 is embedded. The head suspension assembly 62 may further include the load beam 30 coupling through the hinge 70 to the base plate 72.

Manufacturing the head stack assembly 50 of FIG. 2A includes assembling the head stack 54 with the head gimbal assembly 60, the second head gimbal assembly 60-2, the third head gimbal assembly 60-3, and the lateral control signal 82.

Manufacturing the head stack assembly 50 of FIG. 2B includes assembling the head stack 54 with the head gimbal assembly 60, the second head gimbal assembly 60-2, the third head gimbal assembly 60-3, and the fourth head gimbal assembly 60-4, and the lateral control signal 82.

Returning to the overall operation and elements of the hard disk drive. During normal access operations, the spindle motor 270 turns the spindle 40, which in turn rotates at least one disk 12, as shown in FIG. 1. By rotating the disk, the rotating disk surface 120-1 moves about the spindle, supporting the read-write head 94 accessing the track 122. The disk also includes the second rotating disk surface 120-2. The hard disk drive may include more than one disk, by way of example, FIGS. 2A, 2B and 5 show a second disk 12-2. The second disk includes the third rotating disk surface 120-3 and in some embodiments, the fourth rotating disk surface 120-4.

The head stack 54 includes the actuator arm 52 and the second actuator arm 52-2 in FIGS. 1 and 2A. The second actuator arm of FIG. 2A preferably couples to the second head gimbal assembly 60-2 and to the third head gimbal assembly 60-3. The head stack in FIG. 2B further includes a third actuator arm 52-3 coupling to the fourth head gimbal assembly 60-4.

The lateral control signal 82 is transmitted from the servo controller 600 across the main flex circuit 200 to the flexure finger 20, which provides it to the micro-actuator 80, as shown in FIG. 1. The main flex circuit is also used to provide the second flexure finger 20-2 with the lateral control signal. The second flexure finger provides it to the second micro-actuator 80-2. FIG. 2A further shows the main flex circuit being used with the third flexure finger 20-3 to provide the lateral control signal to the third micro-actuator 80-3. FIG. 2B further shows the main flex circuit being used with the fourth flexure finger 20-4 to provide the lateral control signal to the fourth micro-actuator 80-4.

The preceding embodiments provide examples of the invention and are not meant to constrain the scope of the following claims.

What is claimed is:

1. A head stack assembly, comprising:
at least two micro-actuators, each micro-actuator coupling through a separate head gimbal assembly to said head stack;
a lateral control signal driving all of said micro-actuators, further comprising:
said lateral control signal driving each two adjacent of said micro-actuators in opposite lateral directions.

2. The head stack assembly of claim 1, consisting of: two of said micro-actuators.

3. The head stack assembly of claim 1, consisting of: three of said micro-actuators.

4. The head stack assembly of claim 1, wherein at least one of said micro-actuators is driven by a vertical actuation signal to alter the flying height of the read-write head coupling to said micro-actuator through its slider.

5. The head stack assembly of claim 1, wherein said lateral control signal affects at least one of said micro-actuators based upon a piezoelectric effect.

6. The head stack assembly of claim 5, wherein said lateral control signal affects all of said micro-actuators based upon a piezoelectric effect.

7. The head stack assembly of claim 6, wherein each of said two of said micro-actuators of said neighboring head gimbal assemblies is oriented with opposite polings for each element using said piezoelectric effect.

8. The stack assembly of claim 7, wherein each of said micro-actuators includes a first element and a second element, both using said piezoelectric effect to create lateral motion based upon said lateral control signal.

9. The head stack assembly of claim 1, wherein said lateral control signal affects at least one of said micro-actuators based upon an electrostatic effect.

10. A hard disk drive, comprising said head stack assembly of claim 1.

11. A method of manufacturing said hard disk drive of claim 10, comprising the step: using said head stack assembly.

12. The hard disk drive, as a product of the process of claim 11.

13. A method of manufacturing said head stack assembly of claim 1, comprising the steps:
assembling said head stack with said head gimbal assemblies and said lateral control signal so that said lateral control signal drives each two of said micro-actuators in adjacent of said head gimbal assemblies in opposite lateral directions, to create said head stack assembly.

14. The head stack assembly as a product of the process of claim 13.

15. A method of operating the head stack assembly of claim 1, comprising the steps:
driving all of said micro-actuators with said lateral control signal; and
said lateral control signal driving two of said micro-actuators in said neighboring head gimbal assemblies in opposite lateral directions.

16. The method of claim 15,
wherein the step said driving all of said micro-actuators, further comprising one member of the group consisting of the steps:
said all of said micro-actuators contributing essentially no torque onto said head stack assembly based upon said opposite lateral directions of said micro-actuators, when said head stack assembly includes an even number of said micro-actuators;
said all of said micro-actuators contributing essentially said torque onto said head stack assembly based upon the lateral direction of one of said micro-actuators, when said head stack assembly includes an odd number of said micro-actuators.

17. A servo controller implementing the method of claim 15, comprising:
said servo controller coupled to said head stack assembly to provide said lateral control signal to each said micro-actuators included in said head stack assembly.

18. The servo controller of claim 17, comprising: a servo computer accessibly coupled to a memory containing a program system directing said servo computer in support of said method.

19. The servo controller of claim 18, wherein said servo computer includes at least one instruction processor and at least one data processor; wherein each of said data processors is directed by at least one of said instruction processors; and
wherein said memory includes at least one instance of at least one member of the group consisting of a non-volatile memory component and a volatile memory component.

20. An embedded circuit, including the servo controller of claim 15.
